(19) United States
(12) Patent Application Publication
(10) Pub. No.: US 2010/0142198 A1
(43) Pub. Date: Jun. 10, 2010

(54) Configurable Light Emitting System

(76) Inventor: Chih-Wen Yang, Taipei (TW)

Correspondence Address: NORTH AMERICA INTELLECTUAL PROPERTY CORPORATION, P.O. BOX 506, MERRIFIELD, VA, 22116, US

(21) Appl. No.: 12/331,383

(22) Filed: Dec. 9, 2008

(51) Int. Cl. F21V 21/00; F21K 7/00

(52) U.S. Cl. 362/231; 362/227; 362/249.01

(57) ABSTRACT

A configurable light emitting system includes a plurality of light emitting units, at least a first external conductor, and at least a second external conductor. Each of the light emitting units includes an anode, a cathode, a first electrical contact electrically connected to the anode, and a second electrical contact electrically connected to the cathode. The first external conductor is electrically connected to the first electrical contact of each of the light emitting unit, and configured to supply a positive voltage thereto. The second external conductor is electrically connected to the second electrical contact of each of the light emitting unit, and configured to supply a negative voltage thereto. The plurality of the light emitting units are configured as a tile structure or a brick structure, and are electrically connected together through the first external conductor and second external conductor.

### BACKGROUND OF THE INVENTION

1. Field of the Invention

The present invention relates to a light emitting system, and more particularly, to a light emitting system composed of a plurality of light emitting units which can be electrically connected through external conductors and configured as a tile structure or brick structure in any required shapes.

2. Description of the Prior Art

In recent years, light emitting diode (LED) has been widely used as light source for its advantages of low power consumption, durable lifetime, compact size, etc. Due to the characteristic of the point source of LED, however, the application of LED light source has been impeded. In addition, current manufacturing technology limits the ability to economically produce large size flat panel light emitting device due to issues in managing defects. Besides, manufacturing and inventory management issues also lead to limitations in the variety of available flat panel light emitting device sizes. For the aforementioned reasons, these limitations make it uneasy to provide flat panel light emitting devices of different sizes and shapes.

Conventionally, the thickness of existed LED product on market is around 50 mm to 100 mm, and with this kind of thickness, weight cannot be reduced. By virtue of chip-on-board (COB) packaging, printed circuit board (PCB) can be omitted so that the thickness of LED can be greatly decreased to less than 30 mm, which makes it easy to be installed. In addition, the users need not to have misgiving about if the means of installation can afford the heavy weight of the lighting emitting system. Also, its flexibility of installation can be greatly increased.

There is a need therefore for an improved design of flat panel light emitting devices to provide for the design flexibility that is provided by light emitting devices in a wide variety of sizes, and light emitting devices that can be configured into a variety of shapes under the limitation of light weight.

### SUMMARY OF THE INVENTION

It is therefore one of the objectives of the present invention to provide a configurable light emitting system, which has high flexibility of installation, low manufacturing cost, and can be easily customized.

According to the present invention, a configurable light emitting system is provided. The configurable light emitting system includes a plurality of light emitting units, at least a first external conductor, and at least a second external conductor. Each of the light emitting units includes an anode, a cathode, a first electrical contact electrically connected to the anode, and a second electrical contact electrically connected to the cathode. The first external conductor is electrically connected to the first electrical contact of each of the light emitting unit, and configured to supply a positive voltage thereto. The second external conductor is electrically connected to the second electrical contact of each of the light emitting unit, and configured to supply a negative voltage thereto. The plurality of the light emitting units are configured as a tile structure or a brick structure, and the plurality of the light emitting units are electrically connected together through the first external conductor and second external conductor.

The configurable light emitting system of the present invention is advantageous for its low cost, high flexibility of installation, light weight, low thickness and customizable shape.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 schematically illustrates a configurable light emitting system according to an embodiment of the present invention.

FIG. 2 is a cross-sectional view of a single light emitting unit of the light emitting system of FIG. 1.

FIG. 3 is a circuit diagram of the configurable light emitting system of FIG. 1.

FIG. 4 schematic illustrates a configurable light emitting system according to another embodiment of the present invention.

FIG. 5 schematic illustrates a configurable light emitting system according to another embodiment of the present invention.

FIG. 6 is a schematic diagram illustrating a configurable light emitting system according to another embodiment of the present invention.

FIG. 7 is a schematic diagram illustrating a configurable light emitting system according to still another embodiment of the present invention.

FIG. 8 is a schematic diagram illustrating a configurable light emitting system according to yet another embodiment of the present invention.

FIGS. 9-10 respectively depict a configurable light emitting system according to another two embodiments of the present invention.

FIGS. 11-12 respectively depict a configurable light emitting system according to still another two embodiments of the present invention.

### DETAILED DESCRIPTION

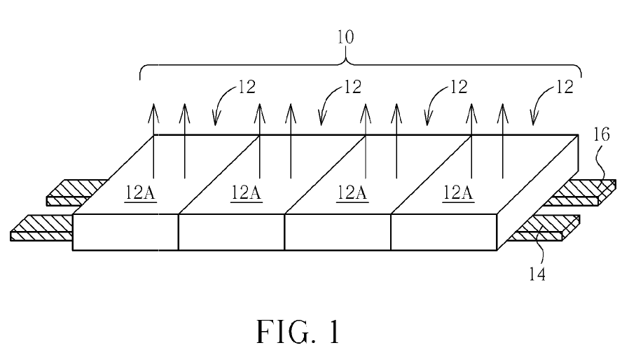

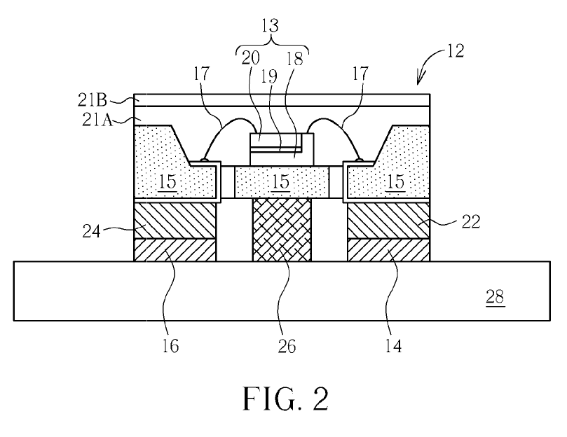

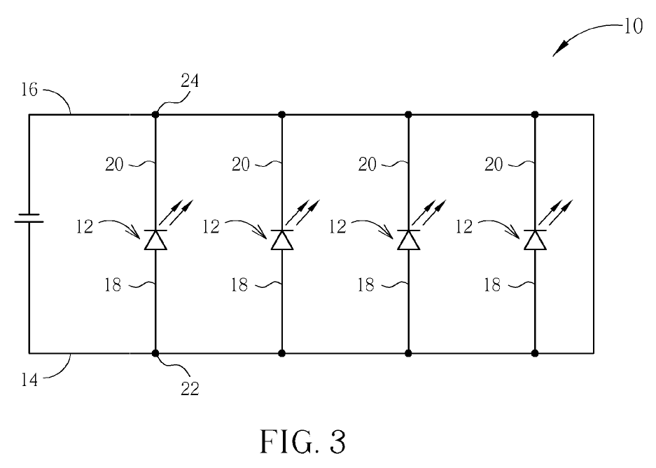

Refer to FIGS. 1-3. FIG. 1 schematically illustrates a configurable light emitting system according to an embodiment of the present invention, FIG. 2 is a cross-sectional view of a single light emitting unit of the light emitting system of FIG. 1, and FIG. 3 is a circuit diagram of the configurable light emitting system of FIG. 1. As shown in FIG. 1 and FIG. 2, the configurable light emitting system 10 mainly includes a plurality of light emitting units 12, at least a first external conductor 14, and at least a second external conductor 16. Each of the light emitting units 12 preferably include at least one light emitting device package structure, but not limited to. Preferably, the thickness of each of the light emitting units 12 is substantially between 5 mm and 30 mm such that the configurable light emitting system of the present invention may have a compact size, which makes it easy to be installed. In this embodiment, the lighting device 13 inside of the light emitting unit 12 is a chip-on-board (COB) type package structure.

The light emitting device 13 may be, for instance, an LED or any other type of light emitting device, and the light emitting device 13, which is mounted on a substrate 15, may include an anode 18, a cathode 20 and a light emitting layer 19 interposed therebetween. Also, the light emitting device 13 is covered with an encapsulation layer 21A for protection and isolation from humidity and dust, and a diffuser 21B disposed on the encapsulation layer 21A for diffusing light beams. The light emitting device 13 is not limited to a COB type package, and may be other types of package such as flip chip (FC) type package, SMT type package, etc. Additionally, the light emitting device 13 in this embodiment is a horizontal type LED, in which the driving current horizontally flows through the light emitting device 13, and heat and electricity are transferred through different paths. The light emitting unit 12 in other embodiments, however, may be a vertical type LED, in which the driving current vertically flows through the light emitting device 13, and heat and electricity are transferred through the same path.

As shown in FIG. 2, the first external conductor 14 is electrically connected to the first electrical contact 22 of the light emitting unit 12, and configured to supply a positive voltage of a power supply to the first electrical contact 22, and the second external conductor 16 is electrically connected to the second electrical contact 24 of the light emitting unit 12, and configured to supply a negative voltage of the power supply to the second electrical contact 24.

As shown in FIG. 3, the light emitting units 12 of the present invention are electrically interconnected through the first external conductor 14 and the second external conductor 16, but not electrically interconnected directly. Therefore, no extra internal conductors are required to be disposed on the edge of the light emitting units 12 to create electrical interconnections between adjacent light emitting units 12.

As shown in FIG. 1 and FIG. 2, the light emitting unit 12 has a light emitting surface 12A, where light beams emit. Since the first external conductor 14 and the second external conductor 16 are disposed on the back surface opposite to the light emitting surface 12A, and no other internal conductors are disposed between adjacent light emitting units 12, the light emitting surfaces 12A of the light emitting units 12 after configured therefore can form a continuous and frameless light emitting surface. In addition, the light emitting units 12 of the configurable light emitting system 10 may comprise red, green, blue, white light emitting units, or the combination of various colors according to different requirements of the products.

In this embodiment, the electrical connection of the configurable light emitting system 10 is implemented by the contact of the first external conductor 14/the second external conductor 16 and the first electrical contact 22/the second electrical contact 24 of each light emitting unit 12 as shown in FIG. 2. The structural connection, on the other hand, is carried out in another manner. For instance, the configurable light emitting system 10 may further include an adhesive layer 26 disposed between each of the light emitting units 12 and a substrate 28, and the adhesive layer 26 adheres the light emitting units 12 to the substrate 28. The substrate 28 may be any forms of substrate, or any physical objects that can fix and support the configurable light emitting system 10. For example, the substrate 28 may be a frame designed to accommodate the light emitting units 12, or even the ceiling, wall or floor on which the light emitting units 12 can be fastened.

The first external conductor 14 and the second external conductor 16 are a pair of conductive bars, normally but not necessarily, fastened on the substrate 28 at predetermined locations, and each of the first electrical contact 22 and the second electrical contact 24 is a plate electrode, such that when each of the light emitting units 12 is mounted on the substrate 28, the plate electrodes are in contact with the pair of the conductive bars. Accordingly, the electrical connection through the contact between the first electrical contact 22/the second electrical contact 24 of each light emitting unit 12 and the first external conductor 14/the second external conductor 16 can be implemented.

In the above embodiment, the electrical connection and the structural connection are separately carried out in different ways. The electrical connection and structural connection of the configurable light emitting system 10, however, are not limited by the above methods, and may be implemented either separately or collectively based on different requirements. Different embodiments will be described as follows.

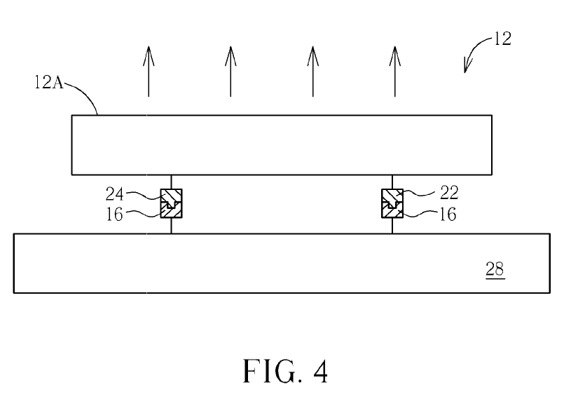

Refer to FIG. 4. FIG. 4 schematic illustrates a configurable light emitting system according to another embodiment of the present invention. In this embodiment, each of the first electrical contacts 22 is electrically connected to the first external conductor 14 via a pin and socket connector, and each of the second electrical contacts 24 is electrically connected to the second external 16 via a pin and socket connector. Specifically, each of the first electrical contact 22 and the second electrical contact 24 is a pin e.g. a male plug or a female plug, and each of the first external conductor 14 and the second external conductor 16 is a socket e.g. a female plug or a male plug. The electrical connection between each of the light emitting units 12 is achieved by plugging the male plugs or female plugs of the light emitting units 12 into the corresponding female plugs or male plugs of the first external conductor 14 and the second external conductor 16. The structural connection between each of the light emitting units 12 and the substrate 28 can be done by an adhesive layer (not shown) or any other fastening mechanism.

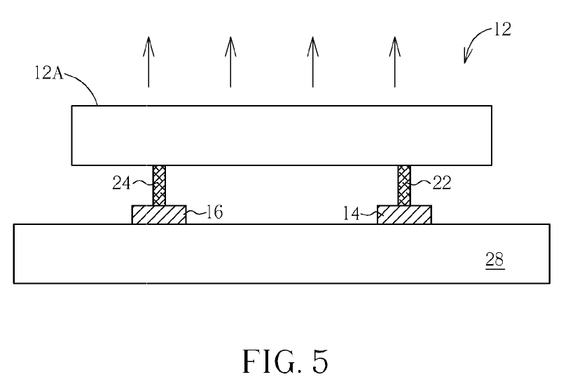

Refer to FIG. 5. FIG. 5 schematic illustrates a configurable light emitting system according to another embodiment of the present invention. Similar to the above embodiment but in this embodiment, each of the first electrical contact 22 and the second electrical contact 24 is another type of pin, and the first external conductor 14 and the second external conductor 16 includes sockets or slots. When the pins of the first electrical contact 22 and the second electrical contact 24 are plugged into the sockets or slots of the first external conductor 14 and the second external conductor 16, not only the electrical connection between each of the light emitting units 12 is achieved, but also the structural connection of each of the light emitting units 12 and the substrate 28 is accomplished. Therefore, no extra mechanical connection is required. It is appreciated that the first external conductor 14 and the second external conductor 16 may includes pins, while each of the first electrical contact 22 and the second electrical contact 24 may be a socket or a slot, correspondingly.

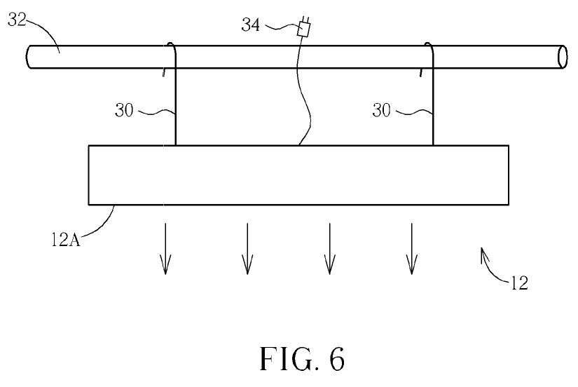

Refer to FIG. 6. FIG. 6 is a schematic diagram illustrating a configurable light emitting system according to another embodiment of the present invention. In this embodiment, each of the light emitting units 12 includes at least a fastening member 30 fastened on a suspending frame 32. For instance, the fastening member 30 may be a hook hooked on the suspending frame 32, which is suspended from the ceiling. The electrical connection can be implemented by any methods such as using a plug 34.

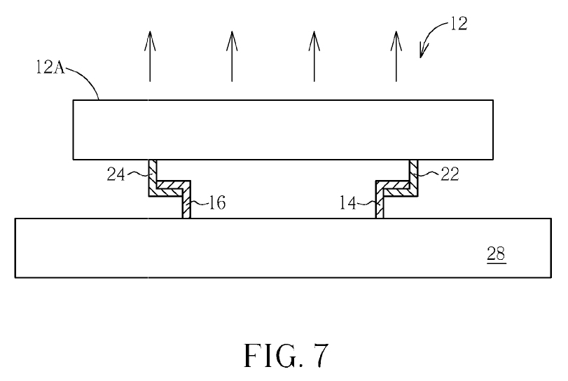

Refer to FIG. 7. FIG. 7 is a schematic diagram illustrating a configurable light emitting system according to still another embodiment of the present invention. In this embodiment, each of the light emitting units 12 includes at least a fastening member able to be lodged into a pair of slide rails, such that the light emitting units 12 can be fastened by the coupling of fastening members and slide rails. Preferably, the first external conductor 14 and the second external conductor 16 may include a pair of slide rails. Correspondingly, each of the first electrical contacts 22 and the second electrical contacts 24 includes a fastening member connected to the pair of slide rails such that each of the light emitting units 12 is fastened on the slide rails. More preferably, the slide rails may be made of conductive material so that each of the first electrical contacts 22 is electrically connected to the first external conductor 14 and each of the second electrical contacts 24 is electrically connected to the second external conductor 16 through the pair of conductive slide rails.

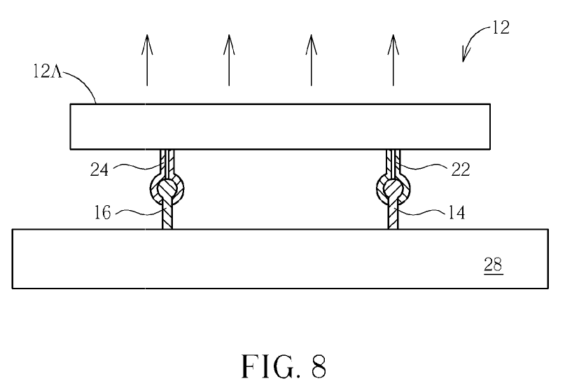

Refer to FIG. 8 FIG. 8 is a schematic diagram illustrating a configurable light emitting system according to yet another embodiment of the present invention. In this embodiment, each of the light emitting units 12 includes a clamp clamping a corresponding joint such that the light emitting units are fastened on the joints. Preferably, the first external conductor 14 and the second external conductor 16 may include a plurality of joints, and each of the first electrical contacts 22 and the second electrical contacts 24 may include at least a clamp clamping the corresponding joint. Accordingly, the light emitting units 10 are mechanically connected to the substrate 28. The joints and the claims are preferably made of conductive materials such that each of the first electrical contacts 22 is electrically connected to the first external conductor 14 and each of the second electrical contacts 24 is electrically connected to the second external conductor 16.

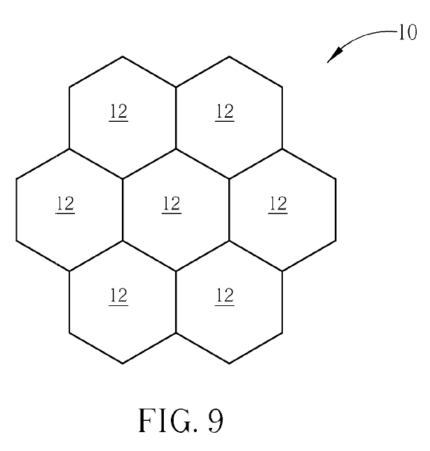

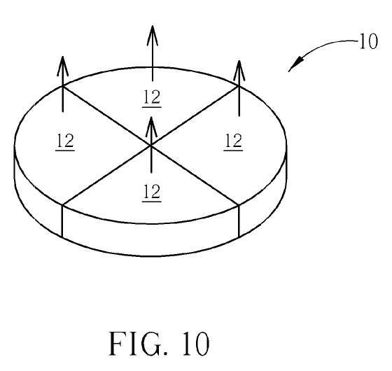

Each of the light emitting unit 12 of the present invention may be a tile unit or a brick unit with the same or different shape, and the plurality of light emitting units 12 may be combined and configured as a tile structure or a brick structure as described in the aforementioned embodiments. The light emitting units 12 can be combined to any desired shapes. In the aforementioned embodiments, each of the light emitting units 12 has a rectangular shape, and these light emitting units 12 are combined as a rectangular-shaped configurable light emitting system 10. The shape of an individual light emitting unit 12 and the shape of a combined configurable light emitting system 10, however, are not limited to be rectangular, and can be modified based on different requirement. For instance, the light emitting unit 12 may be circular, any polygonal shape e.g. triangle, hexagon, etc., and any regular or irregular shapes. The shape of the configurable light emitting system 10 may also be varied based on the requirement of the product. Refer to FIGS. 9-10. FIGS. 9-10 respectively depict a configurable light emitting system according to another two embodiments of the present invention. As shown in FIG. 9, each of the light emitting units 12 is hexagonal, and the number of the light emitting units 12 can be modified. As shown in FIG. 10, each of the light emitting units 12 has a shape of a quarter circle, and these light emitting units 12 form a configurable light emitting system 10 having a circular shape.

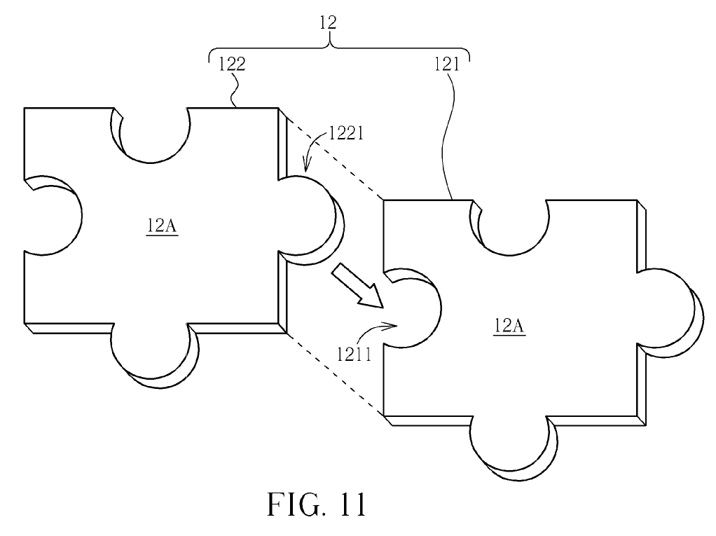

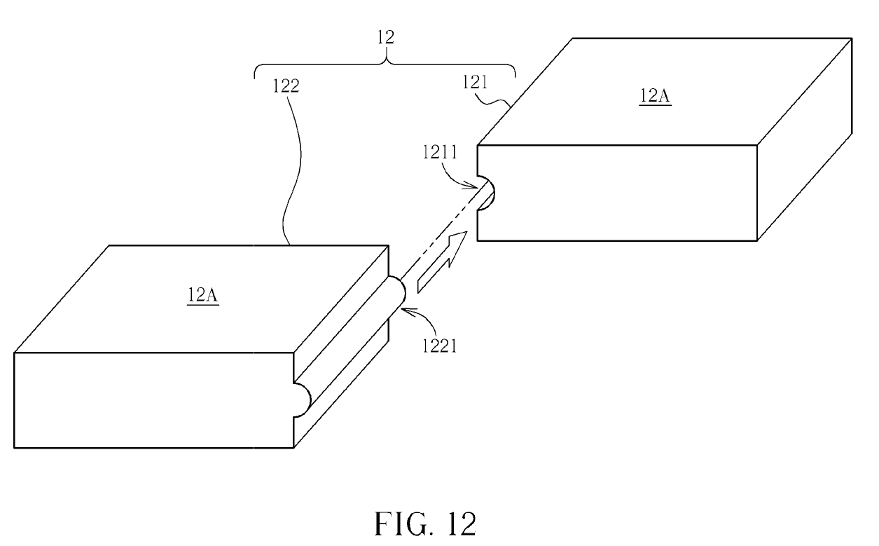

FIGS. 11-12 respectively depict a configurable light emitting system according to still another two embodiments of the present invention. As shown in FIG. 11, each of the light emitting units 12 is like a piece of jigsaw. For instance, a first light emitting unit 121 may include at least a concave part 1211, and a second emitting unit 122 may include at least a convex part 1221 corresponding to the concave part 1211. The convex part 1221 can be embedded into the concave part 1211 along a vertical direction, i.e. the convex part 1221 of the second emitting unit 122 must be engaged with the concave part 1211 along the direction perpendicular to the light emitting surface or the back surface of the first emitting unit 121 as indicated by the arrow. As shown in FIG. 12, the convex part 1221 can be embedded into the concave part 1211 along a horizontal direction, i.e. the convex part 1221 of the second emitting unit 122 must be engaged with the concave part 1211 along the direction parallel to the edge side of the first emitting unit 121 as indicated by the arrow.

In the aforementioned two embodiments, the first light emitting unit 121 and the second light emitting unit 122 are fastened together by engaging the convex part 1221 with the concave part 1211, and other light emitting units 12 may be combined in similar manner to form the configurable light emitting system with a desired shape. The electrical connection between the light emitting units 12 can be achieved by any suitable method disclosed in the specification.

In conclusion, the configurable light emitting system of the present invention has the following advantages. First, the shape, brightness and color of the configurable light emitting system can be easily modified by selecting different shape, number, and color of the light emitting units such that a customized product can be easily provided. Therefore, the configurable light emitting system has high flexibility. In addition, the design of electrical and/or structural connection mechanism makes it very convenient to replace broken light emitting unit. Furthermore, the design of electrical and/or structural connection mechanism reduces manufacturing costs and improves the stability of the configurable light emitting system. Also, the structural connection of the light emitting units allow the configurable light emitting system to have a continuous and frameless light emitting surface of, which makes the configurable light emitting system aesthetic and more applicable.

Those skilled in the art will readily observe that numerous modifications and alterations of the device and method may be made while retaining the teachings of the invention.

What is claimed is:

1. A configurable light emitting system, comprising:
a plurality of light emitting units, each of the light emitting units comprising:
an anode;
a cathode;
a first electrical contact electrically connected to the anode; and
a second electrical contact electrically connected to the cathode;
at least a first external conductor electrically connected to the first electrical contact of each of the light emitting unit, and configured to supply a positive voltage thereto; and
at least a second external conductor electrically connected to the second electrical contact of each of the light emitting unit, and configured to supply a negative voltage thereto;
wherein the plurality of the light emitting units are configured as a tile structure or a brick structure, and the plurality of the light emitting units are electrically connected together through the first external conductor and second external conductor.

2. The configurable light emitting system of claim 1, wherein each of the light emitting unit comprises at least a light emitting diode.

3. The configurable light emitting system of claim 1, wherein each of the light emitting units has a thickness substantially between 5 millimeters (mm) and 30 mm.

4. The configurable light emitting system of claim 1, wherein each of the light emitting units has a light emitting surface, and the light emitting surfaces of the light emitting units after configured form a continuous and frameless light emitting surface.

5. The configurable light emitting system of claim 1, wherein each of the first electrical contacts is electrically connected to the first external conductor via a pin and socket connector, and each of the second electrical contacts is electrically connected to the second external conductor via a pin and socket connector.

6. The configurable light emitting system of claim 1, wherein the first external conductor and the second external conductor comprise a pair of conductive slide rails, and each of the first electrical contacts and the second electrical contacts being in contact with the pair of conductive slide rails such that each of the first electrical contacts is electrically connected to the first external conductor and each of the second electrical contacts is electrically connected to the second external conductor.

7. The configurable light emitting system of claim 1, wherein the first external conductor and the second external conductor comprise a plurality of conductive joints, and each of the first electrical contacts and the second electrical contacts comprises a conductive clamp clamping the corresponding joint such that each of the first electrical contact is electrically connected to the first external conductor and each of the second electrical contact is electrically connected to the second external conductor.

8. The configurable light emitting system of claim 1, wherein the first external conductor and the second external conductor comprise a pair of conductive bars, and each of the first electrical contacts and the second electrical contacts comprises a plate electrode in contact with the pair of the conductive bars such that each of the first electrical contacts is electrically connected to the first external conductor and each of the second electrical contacts is electrically connected to the second external conductor.

9. The configurable light emitting system of claim 1, wherein each of the light emitting units comprises at least a pin plugged into the a corresponding socket such that the light emitting units are fastened on the sockets.

10. The configurable light emitting system of claim 1, wherein each of the light emitting units comprises a pair of fastening members lodged in a pair of slide rails such that the light emitting units are fastened on the pair of slide rails.

11. The configurable light emitting system of claim 1, wherein each of the light emitting units comprises at least a clamp clamping a corresponding joint such that the light emitting units are fastened on the joints.

12. The configurable light emitting system of claim 1, further comprising an adhesive layer disposed between each of the light emitting units and a substrate such that the light emitting units are fastened on the substrate.

13. The configurable light emitting system of claim 1, wherein each of the light emitting units comprises at least a fastening member fastened on a suspending frame.

14. The configurable light emitting system of claim 1, wherein the light emitting units comprises a first light emitting unit and a second light emitting unit, the first light emitting unit comprises at least a concave part disposed on at least an edge side of the first light emitting unit, the second emitting unit comprises at least a convex part disposed on at least an edge side of the second light emitting unit, and the convex part is movably embedded into the concave part such that the first light emitting unit and the second light emitting unit are fastened together.

15. The configurable light emitting system of claim 14, wherein the convex part of the second light emitting unit is movably embedded into the concave part of the first light emitting unit along a direction perpendicular to a light emitting surface or a back surface of the first light emitting unit.

16. The configurable light emitting system of claim 14, wherein the convex part of the second light emitting unit is movably embedded into the concave part of the first light emitting unit along a direction parallel to the edge side of the first light emitting unit.

17. The configurable light emitting system of claim 1, wherein each of the light emitting units has a polygonal shape or a circular shape.

18. The configurable light emitting system of claim 1, wherein the light emitting units comprise red, green, blue, white light emitting units, or a combination thereof.

19. The configurable light emitting system of claim 1, wherein each of the light emitting unit is a chip-on-board (COB) type package structure light emitting diode.
